(19) United States
(12) Patent Application Publication
(10) Pub. No.: US 2026/0052559 A1
(43) Pub. Date: Feb. 19, 2026

(54) POSITIONING REFERENCE SIGNAL CONFIGURATION ALIGNMENT IN WIRELESS COMMUNICATIONS

(71) Applicant: ZTE Corporation, Shenzhen (CN)

(72) Inventors: Yu PAN, Shenzhen (CN); Jianxun AI, Shenzhen (CN); Chuangxin JIANG, Shenzhen (CN); Jing LIU, Shenzhen (CN); Cong WANG, Shenzhen (CN); Mengzhen LI, Shenzhen (CN)

(73) Assignee: ZTE Corporation, Shenzhen (CN)

(21) Appl. No.: 19/314,745

(22) Filed: Aug. 29, 2025

Related U.S. Application Data
(63) Continuation of application No. PCT/CN2023/087124, filed on Apr. 7, 2023.

(51) Int. Cl. H04W 72/542; H04W 74/0833

(52) U.S. Cl. CPC H04W 72/542; H04W 74/0833

(57) ABSTRACT

This document generally relates to wireless communication that includes a user device that sends to a location management function (LMF), alignment information, wherein the alignment information comprises at least one of: a positioning reference signal (PRS) time offset, a PRS time duration, a PRS period index, one or more PRS periodicities, a discontinuous reception (DRX) configuration, an extended DRX (eDRX) configuration, a paging time window (PTW) configuration, or a PRS reception window configuration. The user device receives a PRS configuration according to the alignment information. In addition or alternatively, a radio access node (RAN) node receives from a LMF, a request of alignment information, wherein the alignment information comprises at least one of: a DRX configuration, an eDRX configuration, or a PRS reception window configuration. The RAN node reports to the LMF, the alignment information, and the RAN node transmits a PRS corresponding to the alignment information.

### CROSS-REFERENCE TO RELATED APPLICATIONS

This application is a continuation of co-pending International Patent Application No. PCT/CN2023/087124, filed Apr. 7, 2023. The contents of International Patent Application No. PCT/CN2023/087124 are herein incorporated by reference in their entirety.

### TECHNICAL FIELD

This document is directed generally to relaxed positioning reference signal (PRS) configuration alignment for wireless communication.

### BACKGROUND

A low power high accuracy positioning (LPHAP) user device, which may be configured to optimize power saving while performing positioning, may reduce power consumption by align a positioning reference signal (PRS) configuration and the discontinuous reception (DRX)/enhanced DRX (eDRX) configuration in the time domain, especially in radio resource control (RRC) inactive and/or RRC idle states. Through alignment, the user device 102 may not consume extra ramp-up/ramp-down power when receiving PRS and paging. As such, ways to achieve alignment may be desirable.

### SUMMARY

This document relates to methods, systems, apparatuses and devices for wireless communication. In some implementations, a method for wireless communication includes: sending, by a user device to a location management function (LMF), alignment information, wherein the alignment information comprises at least one of: a positioning reference signal (PRS) time offset, a PRS time duration, a PRS period index, one or more PRS periodicities, a discontinuous reception (DRX) configuration, an extended DRX (eDRX) configuration, a paging time window (PTW) configuration, or a PRS reception window configuration; and receiving, by the user device from the LMF, a PRS configuration according to the alignment information.

In some other implementations, a method for wireless communication includes: receiving, by a location management function (LMF) from a user device, alignment information, wherein the alignment information comprises at least one of: a positioning reference signal (PRS) time offset, a PRS time duration, a PRS period index, one or more PRS periodicities, a discontinuous reception (DRX) configuration, an extended DRX (eDRX) configuration, a paging time window (PTW) configuration, or a PRS reception window configuration; and transmitting, by the LMF to the user device, a PRS configuration according to the alignment information.

In some other implementations, a method for wireless communication includes: receiving, by radio access node (RAN) node from a location management function (LMF), a request of alignment information, wherein the alignment information comprises at least one of: a discontinuous reception (DRX) configuration, an extended DRX (eDRX) configuration, or a positioning reference signal (PRS) reception window configuration; reporting, by the RAN node to the LMF, the alignment information; and transmitting, by the RAN node to a user device, a PRS corresponding to the alignment information.

In some other implementations, a device, such as a network device, is disclosed. The device may include one or more processors and one or more memories, wherein the one or more processors are configured to read computer code from the one or more memories to implement any of the methods above.

In yet some other implementations, a computer program product is disclosed. The computer program product may include a non-transitory computer-readable program medium with computer code stored thereupon, the computer code, when executed by one or more processors, causing the one or more processors to implement any of the methods above.

The above and other aspects and their implementations are described in greater detail in the drawings, the descriptions, and the claims.

### BRIEF DESCRIPTION OF THE DRAWINGS

FIG. 1 shows a block diagram of an example of a wireless communication system.

FIG. 2 shows a block diagram of an example configuration of a wireless access node of the wireless communication system of FIG. 1.

FIG. 3 shows a flow chart of an example method for wireless communication.

FIG. 4 shows a flow chart of another example method for wireless communication.

FIG. 5 shows a flow chart of another example method for wireless communication.

FIG. 6 shows a timing diagram of an example DRX timeline and an example PRS timeline.

FIG. 7 shows a timing diagram of another example DRX timeline and an example PRS timeline.

FIG. 8 shows a timing diagram of an example DRX timeline and example PRS timelines.

FIG. 9 shows a diagram of a total number of preambles.

### DETAILED DESCRIPTION

The present description describes various embodiments of systems, apparatuses, devices, and methods for wireless communications that relates to relaxed positioning reference signal (PRS) configuration alignment.

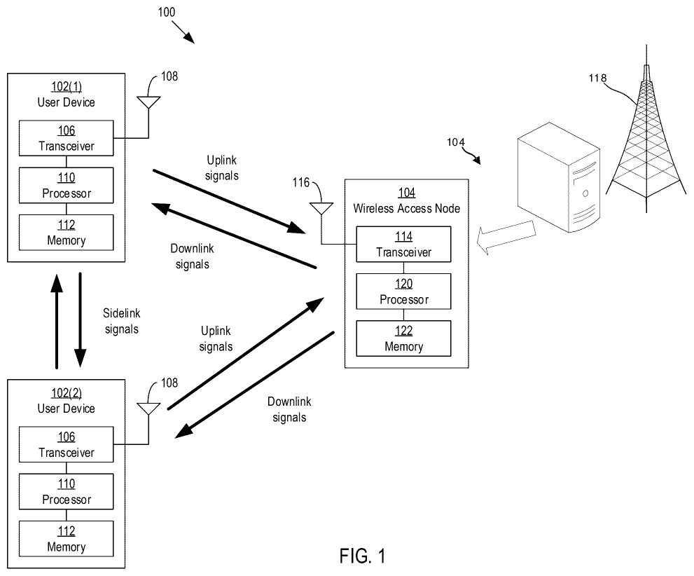

FIG. 1 shows a diagram of an example wireless communication system 100 including a plurality of communication nodes (or just nodes) that are configured to wirelessly communicate with each other. In general, the communication nodes include at least one user device 102 and at least one wireless access node 104. The example wireless communication system 100 in FIG. 1 is shown as including two user devices 102, including a first user device 102(1) and a second user device 102(2), and one wireless access node 104. However, various other examples of the wireless communication system 100 that include any of various combinations of one or more user devices 102 and/or one or more wireless access nodes 104 may be possible.

In general, a user device as described herein, such as the user device 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the wireless access node 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a wireless access node as described herein, such as the wireless access node 104, may include at least one device, electronic and/or network device or apparatus, and may comprise one or more base stations or other wireless network access points capable of communicating wirelessly over a network with one or more user devices and/or with one or more other wireless access nodes 104. For example, the wireless access node 104 may comprise at least one of: a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, or a location management function (LMF), in various embodiments. A wireless access node 104 may include transceiver circuitry 114 coupled to an antenna 116, which may include an antenna tower 118 in various approaches, to effect wireless communication with the user device 102 or another wireless access node 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

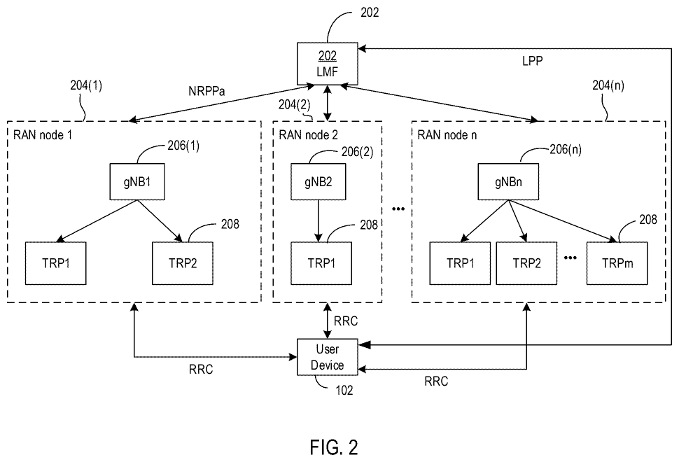

FIG. 2 shows a block diagram of an example configuration of a wireless access node 104. In the example configuration, the wireless access node 104 may include a location management function (LMF) 202 and one or more radio access network (RAN) nodes 204. Some embodiments may include only one RAN node 204. Other embodiments, such as shown in FIG. 2, may include a plurality, or an n-number, of RAN nodes 204(1) to 204(n), where n is two or more. Additionally, each component of the wireless access node 104, such as the LMF 202 and each RAN node 204, may include at least one network device, and/or may be configured in hardware or a combination of hardware and software, such as by having a processor 120, a memory 122, transceiver circuitry 114, an antenna 116, and/or an antenna tower 118, such as shown in FIG. 1 for the wireless access node 104.

Additionally, as shown in FIG. 2, the LMF 202 and each of the RAN nodes 204 may be configured to communicate (transmit and receive) with each other, such as signals or messages, and may be configured to communicate (transmit and receive) with one or more user device 102, either directly or indirectly via another component of the wireless access node 104. For example, the LMF 202 may directly communicate with a user device 102. In particular embodiments, the LMF 202 may directly communicate with a user device 102 according to a Long-Term Evolution (LTE) positioning protocol (LPP) (i.e., via LPP signaling). Also, a RAN node 204 may directly communicate with a user device 102. In particular embodiments, a RAN node 204 may directly communicate with a user device 102 at least via radio resource control (RRC) signaling. In addition, the LMF 202 may directly communicate with each RAN node 204. In particular embodiments, the LMF 202 may directly communicate with each RAN node 204 according to New Radio Positioning Protocol A (NRPPa) (i.e., via NRPPa signaling). Also, for at least some embodiments, such as shown in FIG. 2, each RAN node 204 may include one or more sub-components. For example, a RAN node 204 may include a gNB and/or at least one transmission/reception point (TRP) 208. Further functionality of the LMF 202 and the RAN nodes 204 is described in further detail below.

In addition, referring back to FIG. 1, in various embodiments, two communication nodes in the wireless system 100—such as a user device 102 and a wireless access node 104, two user devices 102 without a wireless access node 104, or two wireless access nodes 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a source/transmitting node and a destination/receiving node.

Also, particular signals can be characterized or defined as either an uplink (UL) signal, a downlink (DL) signal, or a sidelink (SL) signal. An uplink signal is a signal transmitted from a user device 102 to a wireless access node 104. A downlink signal is a signal transmitted from a wireless access node 104 to a user device 102. A sidelink signal is a signal transmitted from a one user device 102 to another user device 102, or a signal transmitted from one wireless access node 104 to a another wireless access node 104. Also, for sidelink transmissions, a first/source user device 102 directly transmits a sidelink signal to a second/destination user device 102 without any forwarding of the sidelink signal to a wireless access node 104.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals.

For at least some specifications, such as 5G NR, data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels) are used to transmit data signals, and physical control channels (or just control channels) are used to transmit control signals. Example types of physical data channels include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a wireless access node 104 to a user device 102. In other embodiments, the control information includes uplink control information (UCI) that is transmitted in the uplink direction from a user device 102 to a wireless access node 104, or sidelink control information (SCI) that is transmitted in the sidelink direction from one user device 102(1) to another user device 102(2).

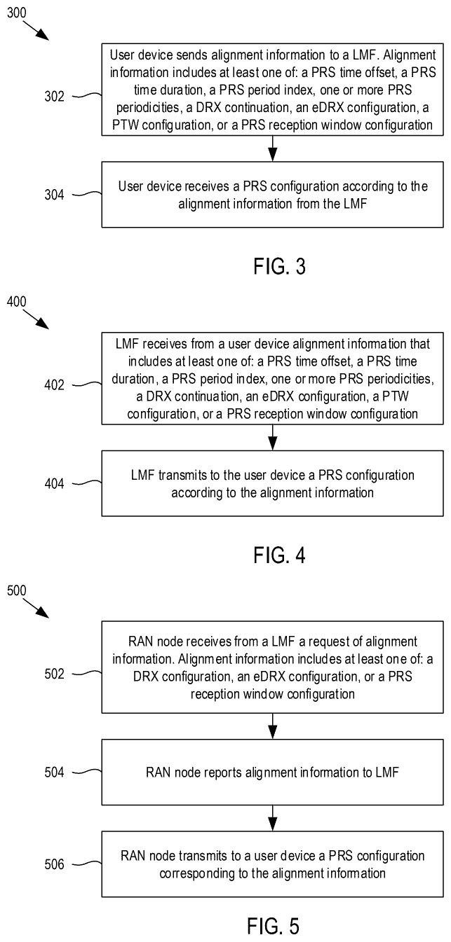

FIG. 3 shows a flow chart of example method 300 for wireless communication involving alignment information in connection with a positioning reference signal (PRS) configuration. At block 302, a user device 102 may send alignment information to a location management function (LMF), such as the LMF 202 in FIG. 2. The alignment information may include at least one of: a PRS time offset, a PRS time duration, a PRS period index, one or more PRS periodicities, a discontinuous reception (DRX) configuration, an extended DRX (eDRX) configuration, a paging time window (PTW) configuration, or a PRS reception window configuration. At block 304, the user device 102 may receive a PRS configuration according to the alignment information from the LMF 202.

FIG. 4 shows a flow chart of an example method 400 for wireless communication involving alignment information in connection with a PRS configuration. At block 402, a location management function (LMF), such as the LMF 202 of FIG. 2, may receive from a user device 102 alignment information. The alignment information may include at least one of: a PRS time offset, a PRS time duration, a PRS period index, one or more PRS periodicities, a discontinuous reception (DRX) configuration, an extended DRX (eDRX) configuration, a paging time window (PTW) configuration, or a PRS reception window configuration. At block 404, the LMF 202 may transmit to the user device 102 a PRS configuration according to the alignment information.

In some embodiments of the method 300 and/or the method 400, the LMF 202 may send to a radio access network (RAN) node 204, the alignment information.

In some embodiments of the method 300 and/or the method 400, the PRS time offset may include one or more PRS time offset values associated with each PRS periodicity of the one or more PRS periodicities.

In some embodiments of the method 300 and/or the method 400, the PRS time duration may include one or more PRS time duration values associated with each PRS periodicity of the one or more PRS periodicities.

In some implementations of the method 300 and/or the method 400, the PRS period index may include at least one of a first PRS period index or a second PRS period index. The first PRS period index may be used to indicate a number of multiple PRS periods, and the second PRS period index may be used to indicate an index of a PRS period among the multiple PRS periods. In addition, the first PRS period index and the second PRS period index are associated with each PRS periodicity of the one or more PRS periodicities.

In some implementations of the method 300 and/or the method 300, at least one of the one or more PRS periodicities is larger than 10,240 milliseconds.

In some implementations of the method 300 and/or the method 400, the user device 102 may send the alignment information by sending, to the LMF 202, the one or more PRS periodicities associated with the PTW configuration, wherein at least one of the one or more PRS periodicities corresponds to a paging location inside the PTW, and at least one other of the one or more PRS periodicities corresponds to a paging location outside the PTW.

In some implementations of the method 300 and/or the method 400, the one or more PRS periodicities may include a list of a plurality of PRS periodicities ordered from a highest priority to a lowest priority.

In some implementations of the method 300 and/or the method 400, the PRS time offset may include at least one of: a hyperframe offset, a radio frame offset, a subframe offset, a slot offset, or a symbol offset.

In some implementations of the method 300 and/or the method 400, the DRX configuration or the eDRX configuration may include: a DRX cycle value or a eDRX cycle value that the user device adopts at least one of within a PTW or outside of the PTW; a start time of a first physical downlink control channel (PDCCH) monitoring occasion for paging associated with a paging occasion (PO); a number of PDCCH monitoring occasions for paging associated with a paging occasion (PO); a start time of a paging frame (PF) associated with a DRX cycle or an eDRX cycle; a start time of a PO associated with a PF; a number of PFs in a DRX cycle or in an eDRX cycle; a number of POs of a PF; a start time of a paging hyperframe associated with a PTW; a start time of a PTW in a paging hyperframe; an end time of a PTW in a paging hyperframe; or a time length of a PTW in a paging hyperframe.

In some implementations of the method 300 and/or the method 400, the PRS reception window configuration may include at least one of: a periodicity of a PRS reception window; a time offset between a start time of a PRS reception window and a start time of a DRX cycle or an eDRX cycle that the PRS reception window belongs; or a length of a PRS reception window.

FIG. 5 shows another example method 500 of wireless communication that involves alignment information in connection with a PRS configuration. At block 502, a RAN node, such as one of the RAN nodes 204 in FIG. 2, may receive from a LMF 202 a request of alignment information. The alignment information may include at least one of: a DRX configuration, an eDRX configuration, or a PRS reception window configuration. At block 504, the RAN node may report the alignment information to the LMF 202. At block 506, the RAN node may transmit to a user device 102 a PRS configuration corresponding to the alignment information. In some embodiments of the method 500, the RAN node may include a serving RAN node of the user device 102.

Further details, which may be part of one or more of the methods 300, 400, 500, are now described.

In some embodiments, a PRS periodicity, which may be a unit in milliseconds (ms)/subframe), may include: {4, 5, 8, 10, 16, 20, 32, 40, 64, 80, 160, 320, 640, 1280, 2560, 5120, 10240}. In addition or alternatively, in some embodiments, a DRX cycle value for RAN paging and core network (CN) paging (in units of subframe) may include: {320, 640, 1280, 2560}. In addition or alternatively, in some embodiments, an eDRX cycle value for RAN paging (in units of subframe) may include: {2560, 5120, 10240}. In addition or alternatively, an eDRX cycle value for CN paging (in units of hyperframe) may include: {¼, ½, 1, 2, 4, 8, 16, 32, 64, 128, 256, 512, 1024}. In addition or alternatively, a paging time window length (in units of 1.28 second) may include: {1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32}.

In some embodiments, the paging location can include at least one of: a paging frame (PF) location, a paging occasion (PO) location, a PDCCH monitoring occasion (MO) location, or a paging time window (PTW) location. The PF/PO/MO/PTW location is for a DRX or a eDRX configuration with a paging cycle value.

In addition, in some embodiments, a requested PRS periodicity may be within one UE on-demand PRS request, or the requested PRS periodicity may be within one PRS frequency layer configuration of a UE on-demand PRS request.

In addition or alternatively, in some embodiments, if there is a need of power saving while positioning in a radio resource control (RRC) inactive state (e.g., RRC_INACTIVE) and/or in a RRC idle stage (e.g., RRC_IDLE), the user device 102 may request a dedicated PRS configuration via LPP signaling. In some of these embodiments, a dedicated PRS configuration is a PRS configuration in the time domain that is close to (or that aligns with) the current UE paging location of RAN paging and/or CN paging in the time domain. A current UE paging location of RAN paging and/or CN paging may first be determined by the user device, such as according to Third Generation Partnership Project (3GPP) Technical Specification (TS) 38.304.

In addition or alternatively, in some embodiments, the user device 102 is configured with DRX and not configured with eDRX, or the user device 102 is configured with DRX and eDRX but eDRX is not on (i.e., the user device 102 currently adopts a DRX configuration and has certain paging location within a settled DRX cycle). For such embodiments, in event that the user device 102 requests a PRS periodicity that is larger than the DRX cycle value, the user device 102 may also request more than one PRS time offset regarding the requested PRS periodicity. The more than one PRS time offset may indicate multiple paging locations within multiple DRX cycles of one requested PRS period. Each of the more than one PRS time offset may indicate each paging location within one DRX cycle. This is to let the network 104 know the user device's 102 paging locations in the requested PRS period and enable the network 104 to configure the PRS to suit multiple paging locations. For at least some embodiments, the PRS time offset may indicate the start time of the paging frame (PF), the paging occasion (PO) or the first monitoring occasion (MO) in a paging cycle.

In addition or alternatively, the user device 102 may also request a PRS time duration regarding each periodicity, to indicate to the LMF 202 how long the PRS is expected to be received during one PRS period. The user device 102 may also request a PRS time duration regarding the one or more time offsets of a periodicity. The PRS time duration regarding each time offset can be the same or different.

In addition or alternatively, in some embodiments, the user device 102 may determine the requested PRS periodicity, the PRS time offset value and/or the PRS time duration value based on UE implementation. In other embodiments, the user device 102 may determine the requested PRS periodicity, the PRS time offset value and/or the PRS time duration value based on its current DRX configuration and/or a PRS reception window configuration.

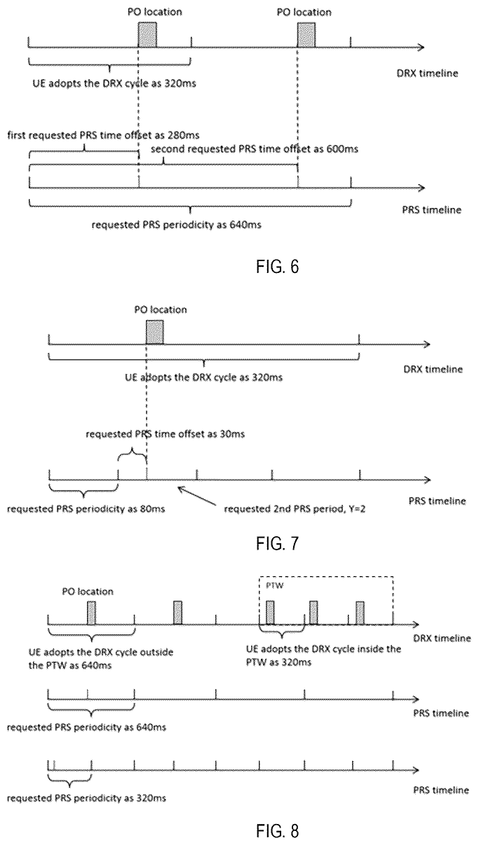

FIG. 6 shows a timing diagram of an example DRX timeline and an example PRS timeline. The timing diagram illustrates the user device 102 sending a request when the PRS periodicity is larger than the DRX cycle. Additionally, the timing diagram shows a situation where the user device 102 adopts a DRX cycle of 320 milliseconds (ms), and the user device 102 requests a 640 ms period of PRS, with the requested PRS time offset as 280 ms and 600 ms.

In addition or alternatively, in some embodiments, the user device 102 may request a PRS periodicity that is the same as the DRX cycle value. In such embodiments, the user device 102 may also request a PRS time offset regarding the requested PRS periodicity. Since, in these embodiments, the PRS periodicity and the DRX cycle are the same, only one time offset value to indicate paging location is sufficient. Additionally, the PRS time offset may indicate the start time of the PF, the PO or the first MO in a paging cycle. In some of these embodiments, in event that one user device 102 has multiple POs or multiple PFs in a paging cycle to monitor paging, the user device 102 may request more than one PRS time offset regarding the requested PRS periodicity, where each of the more than one PRS time offset corresponds to one PO or PF location in a paging cycle.

In addition or alternatively, in some embodiments where the user device 102 requests a periodicity that is the same as the DRX cycle value, the user device 102 may also request a PRS time duration regarding each periodicity, to indicate to the LMF 202 how long the PRS is expected to be received during one PRS period. The user device 102 may also request a PRS time duration regarding the one or more PRS time offsets of a periodicity. The time duration regarding each PRS time offset may be the same or different.

In addition or alternatively, the user device 102 may also include an indication of the purpose of the on-demand PRS request. The indication may include whether user device 102 is asked for the alignment between PRS and DRX.

In addition or alternatively, in some embodiments, the user device 102 may request a PRS periodicity smaller than the DRX cycle value. In such embodiments, the user device 102 may also indicate a PRS period index and a time offset value to the LMF 202 in the request message. The PRS period index may include at least one of a first PRS period index or a second PRS period index. The first PRS period index, e.g., X, may be used to indicate a number of multiple PRS periods. The second PRS period index, e.g., Y, may be used to indicate a Yth PRS period among the X PRS periods. In other embodiments, the Y may be used to indicate how many PRS periods are between the first PRS period (among the X PRS periods) and the requested certain PRS period (among the X PRS periods). In addition or alternatively, the time offset value may indicate the time offset between the start time of the Yth PRS period and the start time of a requested PRS time location within the Yth PRS period.

In addition or alternatively, the user device 102 may also request a PRS time duration regarding each periodicity, to indicate to the LMF 202 how long the PRS is expected to be received during one PRS period. The user device 102 may also request a PRS time duration regarding the one or more time offsets of a periodicity. The PRS time duration regarding each time offset may be the same or different.

FIG. 7 shows a timing diagram of an example DRX timeline and an example PRS timeline. FIG. 7 illustrates an example situation of the user device's 102 PRS request when the PRS periodicity is smaller than the DRX cycle. To illustrate as examples, a DRX cycle may be 320 ms, a requested PRS periodicity may be 80 ms, X=4, and if the value range of Y is {0, 1, 2, 3, . . . }, then Y=1; if the value range of Y is {1, 2, 3, 4, . . . }, then Y=2. Additionally, the requested time offset is 30 ms, which is with respect to the start time of the Yth PRS period.

In addition or alternatively, in some embodiments, a user device 102 may be configured with eDRX and the eDRX is on. In such embodiments, if the user device 102 currently has one or more paging time windows (PTWs) for RAN paging and/or CN paging, the periodicity of a paging location in the PTW and outside of the PTW may be different for a user device 102. To illustrate, suppose that the number of PTWs that the user device 102 currently remains is P, the user device 102 requests P+Q PRS configurations to the LMF 202. Among them, the P PRS configurations are for P PTWs, respectively, and the other Q PRS configurations are for the alignment of PRS and the paging location outside the PTW in the paging cycle/extended paging cycle. As used in the example, P is an integer equal to 1 or larger than 1, Q is an integer equal to 1 or larger than 1. The PRS configuration includes at least one of: one or more PRS periodicities, one or more PRS time offsets, or one or more PRS time durations. In addition or alternatively, in some of these embodiments, the user device 102 may request one or more PRS time offsets and/or one or more PRS time durations associated with each requested PRS periodicity, or the user device 102 may request a PRS time offset and/or a PRS time duration associated with all the requested PRS periodicities. In addition or alternatively, in some of these embodiments, the user device 102 may request a start time of a PRS and an end time of a PRS, taking the PTW configuration into consideration. To be specific, the start time of PRS is the start time of a PTW, and an end time of PRS is the end time of the PTW. The PTW may be the closest upcoming PTW regarding the time that the user device 102 makes the on-demand PRS requests.

To illustrate as an example, suppose P=1 and Q=1. Inside the PTW, the user device 102 adopts a DRX or eDRX value as 320 ms. Additionally outside the PTW, the user device 102 adopts a DRX or eDRX value as 640 ms. Under these conditions, the user device 102 may request two PRS periodicities, one being 640 ms, and the other being 320 ms. Each PRS periodicity may be associated with one or more PRS time offsets and one or more PRS time durations.

FIG. 8 shows a timing diagram of an example DRX timeline and example PRS timelines. The timing diagram of FIG. 8 may show an example of the user device's 102 PRS request when it is configured with a PTW.

In other embodiment where the user device 102 is not configured with a PTW, the user device 102 may only monitors paging during the eDRX cycle for RAN paging and/or CN paging. In such embodiments, the user device 102 may behave the same as configurations where the user device 102 is configured with DRX and not configured with eDRX, or the user device 102 is configured with DRX and eDRX but eDRX is not on′ as described above, such as by replacing a DRX cycle with an eDRX cycle.

In addition or alternatively, the PRS time offset or the time offset may include at least one of: a hyperframe offset, a radio frame offset, a subframe offset, a slot offset, or a symbol offset. In any of various embodiments, the unit of hyperframe offset is a hyperfame, the unit of radio frame offset is a radio frame, the unit of subframe offset is a subframe, the unit of slot offset is a slot, and the unit of symbol offset is a symbol. In addition or alternatively, the unit of a PRS time duration may be at least one of: a hyperframe, a radio frame, a subframe, a slot, or a symbol.

In addition or alternatively, in some embodiments, the requested more than one PRS periodicity values may be associated with a priority indication. In other embodiments, the requested PRS periodicity may be in the form of a list that includes one or more PRS periodicity values ordered from highest priority to the lowest priority. In other embodiments, the requested more than one PRS time offset values may be associated with the priority indication, or the requested PRS time offset list includes one or more PRS time offset values ordered from highest priority to the lowest priority. In other embodiments, the requested more than one PRS time duration values may be associated with the priority indication, or the requested PRS time duration list may include one or more PRS time duration values ordered from highest priority to the lowest priority.

In addition or alternatively in some embodiments, the PRS periodicity may be extended to be larger than 10240 ms. In addition or alternatively, the value range of the PRS periodicity may include at least one of: {2, 4, 8, 16, 32, 64, 128, 256, 512, 1024}, where the unit is a hyperframe. Such embodiments may suit the eDRX cycle value for RRC_INACTIVE and/or RRC_IDLE.

In addition or alternatively, if there is a need of power saving while positioning in the RRC inactive state (e.g., RRC_INACTIVE) and/or the RRC idle state (e.g., RRC_IDLE), the user device 102 may report the DRX or eDRX configuration on where it monitors paging (e.g., paging location) to the LMF 202, such as via LPP signaling. Doing so may inform the LMF 202 and/or NG-RAN nodes 204 so that they may provide and/or configure a suitable PRS configuration that is close to (or that align with) the reported UE paging location of RAN paging and/or CN paging in the time domain. For such embodiments, the current UE paging location of RAN paging and/or CN paging may be first determined by the user device, such as according to 3GPP TS 38.304.

In addition or alternatively, in the request/report message, the user device 102 may include at least one of the following: the DRXcycle value or the eDRX cycle value that the user device 102 adopts within a PTW and/or outside of the PTW; the start time of the first MO for paging associated with the PO; the number of MOs for paging associated with the PO; the start time of the PF associated with the DRX/eDRX cycle; the start time of the each PO associated with the PF; the number of total PF in the DRX/eDRX cycle; the number of POs for a PF; the start time of a paging hyperframe associated with a PTW; the start time of the PTW in the paging hyperframe; the end time of the PTW; or the time length of the PTW.

In addition or alternatively, in some embodiments, the user device 102 may be configured with a PRS reception window to receive PRS in RRC_IDLE and/or RRC_INACTIVE. The PRS reception window may be close to or align with the paging location. The user device 102 may be restricted to only receive PRS inside the PRS reception window in order to save power. In some embodiments, the user device 102 may report the PRS reception window configuration to the LMF 202 via LPP signaling. This, in turn, may allow the user device 102 to save power while positioning in the RRC inactive state and/or the RRC idle state. Also, the reporting may allow the LMF 202 and/or the NG-RAN nodes 204 to provide and/or configure a suitable PRS configuration that is close to (or within) the reported UE PRS reception window in the time domain.

In addition or alternatively, in some embodiments, in the request/report message, the user device 102 may include at least one of the following: the periodicity of the PRS reception window; the time offset between the start time of the PRS reception window and the start time of a DRX cycle that the PRS reception window belongs; or the length of the PRS reception window.

In addition or alternatively, in some embodiments, in event that a NG-RAN node 204 knows a user device's 102 DRX information, eDRX information, and/or the PRS reception window configuration, the NG-RAN node 204 may report or update the user device's 102 DRX information, eDRX information (paging location), and/or the PRS reception window configuration to the LMF 202, such as via NRPPa signaling. In turn, the LMF 202 may make a LMF-initiated on-demand PRS request to the NG-RAN nodes 204. The signaling procedure may include at least one of the following actions: the LMF 202 may request a (serving) NG-RAN node 204 to provide assistance information on the PRS/DRX alignment; the (serving) NG-RAN node 204 provides the user device's DRX/eDRX information and/or the user device's PRS reception window configuration to the LMF 202. In doing so, the NG-RAN node 204 may report at least one of the following: the DRX cycle value and/or the eDRX cycle value that the user device 102 adopts within a PTW and/or outside of the PTW; the start time of the first MO for paging associated with the PO; the number of MOs for paging associated with the PO; the start time of the PF associated with the DRX/eDRX cycle; the start time of the PO associated with the PF; the number of total PF in the DRX/eDRX cycle; the number of POs for a PF; the start time of a paging hyperframe associated with the PTW; the start time of the PTW in the paging hyperframe; the end time of the PTW; the time length of the PTW; the periodicity of the PRS reception window; the time offset between the start time of the PRS reception window and the start time of a DRX cycle that the PRS reception window belongs; or the length of the PRS reception window.

In addition or alternatively, in some embodiments, the LMF 202 requests NG-RAN node(s) 204 to configure PRS according to the LMF initiated on-demand PRS request. The LMF's request is described in further detail below. In addition or alternatively, the NG-RAN node(s) 204 may provide the PRS configuration to the LMF 202. In addition or alternatively, the user device 102 may receive PRS configuration via the LMF 202 or via broadcast RRC signaling. In addition or alternatively, the NG-RAN nodes 204 may send the PRS according to the PRS configuration to the user device 102.

In addition or alternatively, in event a user device's request message to align to a DRX configuration, as previously described, is received by the LMF 202, such as via LPP signaling, the LMF 202 may take the user device's 102 request (assuming there are one or more user devices 102 that have this requirement and send the request) into consideration. In turn, the LMF 202 may determine final PRS configuration characteristics, and the LMF 202 requests the NG-RAN node(s) 204 to provide the PRS configuration.

In other embodiments, in event the LMF 202 receives assistance information on the PRS/DRX alignment provided by the (serving) NG-RAN node 204, such as previously described, the LMF 202 may then determine final PRS configuration characteristics using the assistance information, and in turn, the LMF 202 may request the NG-RAN node(s) 204 to provide the PRS configuration.

In addition or alternatively, in some embodiments, the NRPPa signaling that is used to request the NG-RAN node(s) 204 to configure the PRS configuration may include at least one of: a requested PRS periodicity list, a requested PRS time offset list, or a requested PRS time duration. The requested PRS periodicity list, which may include one or more requested PRS periodicities. In some embodiments, the PRS periodicities in the PRS periodicity list are ordered from highest order to the lowest order. The requested PRS time offset list may include one or more requested PRS time offset values, where the requested PRS time offset list can be per PRS periodicity configured, or per requested PRS NRPPa message configured. Alternatively, the PRS time offset in the PRS time offset list may be ordered from highest order to the lowest order. The requested PRS time duration may be associated with each requested PRS periodicity. Alternatively, the requested PRS time duration may be associated with each requested PRS periodicity list. Alternatively, the requested PRS time duration is associated with each requested PRS time offset. Alternatively, the requested PRS time duration is associated with each requested PRS time offset list.

In addition or alternatively, the LMF 202 may send the above request message to multiple NG-RAN nodes 204 that are required to configure and/or send DL-PRS.

In addition or alternatively, in some embodiments, the LMF 202 may send the PRS configuration of all the TRPs 208 to multiple NG-RAN nodes 204. In such embodiments, the PRS configuration may allow the multiple NG-RAN nodes 204 to configure and/or determine the suitable DRX configuration that is aligned or close to the PRS configuration. In some of these embodiments, if a PRS validity area is enabled, the multiple NG-RAN nodes 204 may correspond to the cells in the validity area cell list.

In other embodiments, in event that the user device is in an RRC inactive state, the LMF 202 may sends the PRS configuration of all the TRPs 208 to the last serving NG-RAN node 204. In turn, if the user device 102 moves out of the area of the last serving NG-RAN node 204, last serving NG-RAN node 204 may forward the PRS configuration of all the TRPs 208 to other NG-RAN nodes via an Xn interface. Doing so may let other NG-RAN nodes 204 configure one or more suitable DRX configurations for the user device 102.

In addition or alternatively, in some embodiments, a sounding reference signal (SRS) configuration (or SRS resource set, or SRS resource) in RRC_INACTIVE may be configured for one cell (e.g., a serving cell or a camping cell), or for multiple cells within a validity area, or for pre-configured multiple SRS configurations.

Additionally, a SRS may be transmitted by a user device 102 in RRC_INACTIVE. The user device 102 may receive the positioning SRS configuration for transmission in RRC_INACTIVE. The positioning SRS configuration may include one or more positioning SRS resource sets, where each positioning SRS resource set may include one or more positioning SRS resources. Also, in some embodiments, each positioning SRS resource set is associated with a pathloss reference signal (RS), which may indicate the power compensation value of every SRS resource in the SRS resource set. The pathloss reference RS for positioning SRS can be SSB (serving cell or neighbor cell) or DL-PRS.

Also, in some embodiments, a user device 102 may determine a SRS validation in RRC_INACTIVE according to a reference signal received power (RSRP) criteria. If the RSRP criteria satisfies and SRS time alignment timer is running, the user device 102 may assume that the SRS is still valid for transmission. In some embodiments, the RSRP criteria is, the current RSRP value of the downlink pathloss reference has not increased/decreased by more than a RSRP threshold (which can be configured by the network 104), compared to the stored downlink pathloss reference RSRP value. If only one SRS resource set is configured in a SRS configuration, the user device 102 may determine the SRS resource set to be valid if it satisfies the RSRP criteria. The user device 102 may determine the SRS resource set to be invalid if it does not satisfy the RSRP criteria. However if one or more SRS resource sets are configured in a SRS configuration, the user device 102 may determine whether the SRS configuration (including the more than one SRS resource sets) is still valid according to one or more of the following ways.

In a first way, each SRS resource set may determine the RSRP criteria individually. If the pathloss reference RSRP of one of the SRS resource set does not satisfy the RSRP criteria, then the SRS resource set is considered to be invalid, and the user device 102 may not send the SRS according to this SRS resource set. In the meantime, if the pathloss reference RSRP of the other SRS resource set satisfies the RSRP criteria, then the SRS resource set is considered to be valid, and the user device 102 may send the SRS according to this SRS resource set. The above situations are assumed to be under a valid time alignment timer, i.e., the SRS time alignment timer is on-going.

In a second way, each SRS resource set may determine the RSRP criteria individually. If the pathloss reference RSRP of one of the SRS resource set does not satisfy the RSRP criteria, then all the SRS resource sets that currently configured to the user device 102 in the current camping cell are assumed to be invalid, and the user device 102 may stop transmitting all the positioning SRS for this current camping cell in RRC_INACTIVE.

In a third way, the user device 102 may first performs the average of the RSRP of the more than one pathloss reference RS associated with more than one SRS resource set. Then, the calculated RSRP can be used at both stored downlink pathloss reference RSRP value and the current RSRP value of the downlink pathloss reference in the RSRP criteria. For example, the weighted average may be applied towards the all RSRPs. Each RSRP value is multiplied by a factor value. If the RSRPs are derived from the same RS type or same RS type with same RS index, the factor value can be 1. If the RSRPs are derived from different RS types or the same RS type with different RS indexes, the factor value can be a value less than 1 or larger than 1. The factor value can be configured by the network 104 (e.g., in a DL RRC message), or the factor value can be reported by the user device 102 as UE capability, or the factor value can be determined according the user device's 102 capability, or the factor value can be pre-defined. Then, the user device 102 may use the calculated RSRP for stored downlink pathloss reference RSRP value and the current RSRP value of the downlink pathloss reference to determine whether the RSRP criteria satisfies or not, then may determine the SRS validation.

In a fourth way, the user device 102 may be restricted to receive one or more SRS resource sets with the same pathloss reference RS type. For example, the user device 102 may be configured with two SRS resource sets in RRC_INACTIVE, and the two SRS resource sets may be configured with the same pathloss reference RS type, e.g., DL PRS.

In a fifth way, the user device 102 may be restricted to receive one or more SRS resource sets with the same configured pathloss reference RS type and the same configured pathloss reference RS index. For example, the user device 102 may be configured with two SRS resource sets in RRC_INACTIVE, and the two SRS resource sets may associate the same pathloss reference RS index, e.g., PRS resource ID 2.

In addition or alternatively, in event that the user device 102 stops a partial or full SRS transmission in the current camping cell in RRC_INACTIVE (e.g., because the user device 102 does not satisfy RSRP criteria, the user device 102 may still be in the validity area or the last serving cell) while the SRS time alignment timer is still running, the user device 102 may take at least one of the following actions. The user device 102 stops the SRS time alignment timer. In addition or alternatively, the user device 102 assumes the SRS time alignment timer expires at this time. In addition or alternatively, the user device 102 notifies the network 104 that the SRS configuration is invalid for the current cell. The indication from the user device 102 to the network 104 can be a UL RRC message, for example, RRCResumeRequest message or RRCResumeRequest1 message or RRCSystemInfoRequest (in Msg 3 or Msg B), UEPositioningAssistanceInfo, UEAssistanceInformation, or ULInformationTransfer, DedicatedSIBRequest. In addition or alternatively, the user device 102 indicates the request of the SRS configuration to the network 104.

In some embodiments, the user device 102 and/or the network 104 may use a RSRP threshold for selecting one or more sets of Random Access resources with Msg1 repetition. The RSRP threshold for selecting the one or more sets of Random Access resources with Msg1 repetition may be configured according to one or more of the following schemes.

In a first scheme, multiple RSRP thresholds may be configured, where each threshold is associated with a repetition number. If the current RSRP of the downlink pathloss reference is lower than multiple thresholds used for Msg1 repetition, the corresponding Msg1 repetitions are applicable for the current Random Access procedure. The user device 102 may select the Random Access resources set with higher repetition number as far as possible if multiple Random Access resources sets are available for any feature applicable to the current Random Access procedure.

In a second scheme, only one RSRP threshold is configured. If the current RSRP of the downlink pathloss reference is lower than the threshold used for Msg1 repetition, the user device 102 may first select the lowest repetition number. When the preamble transmission counter during the current Random Access procedure reaches a predefined value, the user device 102 may use a higher repetition number, up to the highest repetition number.

In addition, in any of various embodiments, the threshold(s) may be configured per-BWP or per-featureCombination.

Additionally, for some embodiments, the Msg1 repetition feature indication may be configured according to one or more of the following schemes.

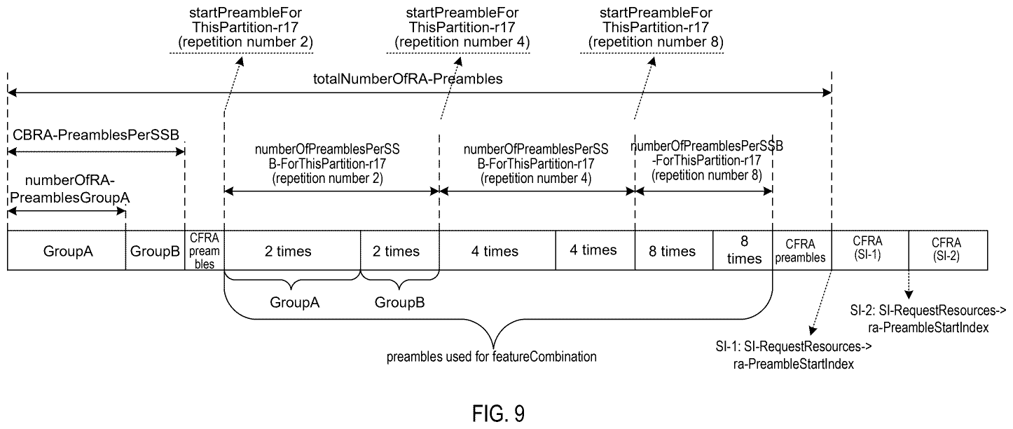

In a first scheme, Msg1 repetition with different repetition numbers is treated as an independent feature. FIG. 9 shows a diagram of a total number of preambles, illustrating Msg1 repetition with different repetition numbers.

In a second scheme, Msg1 repetition with different repetition numbers is treated as one feature. In this case, preambles may be further partitioned for different repetition numbers.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

A first aspect includes a method for wireless communication that includes: sending, by a user device to a location management function (LMF), alignment information, wherein the alignment information comprises at least one of: a positioning reference signal (PRS) time offset, a PRS time duration, a PRS period index, one or more PRS periodicities, a discontinuous reception (DRX) configuration, an extended DRX (eDRX) configuration, a paging time window (PTW) configuration, or a PRS reception window configuration; and receiving, by the user device from the LMF, a PRS configuration according to the alignment information.

A second aspect includes a method for wireless communication that includes: receiving, by a location management function (LMF) from a user device, alignment information, wherein the alignment information comprises at least one of: a positioning reference signal (PRS) time offset, a PRS time duration, a PRS period index, one or more PRS periodicities, a discontinuous reception (DRX) configuration, an extended DRX (eDRX) configuration, a paging time window (PTW) configuration, or a PRS reception window configuration; and transmitting, by the LMF to the user device, a PRS configuration according to the alignment information.

A third aspect includes any of the first or second aspects, and further includes: sending, by the LMF to a radio access network (RAN) node, the alignment information.

A fourth aspect includes any of the first through third aspects, and further includes wherein the PRS time offset comprises one or more PRS time offset values associated with each PRS periodicity of the one or more PRS periodicities.

A fifth aspect includes any of the first through fourth aspects, and further includes wherein the PRS time duration comprises one or more PRS time duration values associated with each PRS periodicity of the one or more PRS periodicities.

A sixth aspect includes any of the first through fifth aspects, and further includes wherein the PRS period index comprises at least one of a first PRS period index or a second PRS period index, wherein the first PRS period index is used to indicate a number of multiple PRS periods, and the second PRS period index is used to indicate an index of a PRS period among the multiple PRS periods, and wherein the first PRS period index and the second PRS period index are associated with each PRS periodicity of the one or more PRS periodicities.

A seventh aspect includes any of the first through sixth aspects, and further includes wherein at least one of the one or more PRS periodicities is larger than 10,240 milliseconds.

An eighth aspect includes any of the first through seventh aspects, and further includes wherein sending the alignment information comprises: sending, by the user device to the LMF, the one or more PRS periodicities associated with the PTW configuration, wherein at least one of the one or more PRS periodicities is determined according to a paging location inside the PTW, and at least one other of the one or more PRS periodicities is determined according to a paging location outside the PTW.

A ninth aspect includes any of the first through eighth aspects, and further includes wherein the one or more PRS periodicities comprises a list of a plurality of PRS periodicity values ordered from a highest priority to a lowest priority.

A tenth aspect includes any of the first through ninth aspects, and further includes wherein the PRS time offset comprises at least one of: a hyperframe offset, a radio frame offset, a subframe offset, a slot offset, or a symbol offset.

An eleventh aspect includes any of the first through tenth aspects, and further includes wherein the DRX configuration or the eDRX configuration comprises: a DRX cycle value or a eDRX cycle value that the user device adopts at least one of within a PTW or outside of the PTW; a start time of a first physical downlink control channel (PDCCH) monitoring occasion for paging associated with a paging occasion (PO); a number of PDCCH monitoring occasions for paging associated with a paging occasion (PO); a start time of a paging frame (PF) associated with a DRX cycle or an eDRX cycle; a start time of a PO associated with a PF; a total number of PFs in a DRX cycle or in an eDRX cycle; a number of POs of a PF; a start time of a paging hyperframe associated with a PTW; a start time of a PTW in a paging hyperframe; an end time of a PTW in a paging hyperframe; or a time length of a PTW in a paging hyperframe.

A twelfth aspect includes any of the first through eleventh aspects, and further includes wherein the PRS reception window configuration comprises at least one of: a periodicity of a PRS reception window; a time offset between a start time of a PRS reception window and a start time of a DRX cycle or an eDRX cycle that the PRS reception window belongs; or a length of a PRS reception window.

A thirteenth aspect includes a method for wireless communication that includes: receiving, by radio access node (RAN) node from a location management function (LMF), a request of alignment information, wherein the alignment information comprises at least one of: a discontinuous reception (DRX) configuration, an extended DRX (eDRX) configuration, or a positioning reference signal (PRS) reception window configuration; reporting, by the RAN node to the LMF, the alignment information; and transmitting, by the RAN node to a user device, a PRS corresponding to the alignment information.

A fourteenth aspect includes the thirteenth aspect, and further includes wherein the RAN node comprises a serving RAN node of the user device.

A fifteenth aspect includes a wireless communications apparatus comprising a processor and a memory, wherein the processor is configured to read code from the memory to implement any of the first through fourteenth aspects.

A sixteenth aspect includes a computer program product comprising a computer-readable program medium comprising code stored thereupon, the code, when executed by a processor, causing the processor to implement any of the first through fourteenth aspects.

In addition to the features mentioned in each of the independent aspects enumerated above, some examples may show, alone or in combination, the optional features mentioned in the dependent aspects and/or as disclosed in the description above and shown in the figures.

1. A method for wireless communication, the method comprising:
receiving, by a user device, at least one reference signal received power (RSRP) threshold, wherein each of the at least one RSRP threshold is associated with a respective one of multiple Msg1 repetition numbers; and
selecting, by the user device, one or more sets of Random Access resources with Msg1 repetition based on the at least one RSRP threshold.

2. The method of claim 1, wherein one or more of the multiple Msg1 repetition numbers associated with one or more of the at least one RSRP threshold is applicable for a current Random Access procedure in response to a current RSRP of a downlink pathloss reference being lower than one or more of the at least one RSRP threshold.

3. The method of claim 1, wherein the one or more sets of Random Access resources comprises multiple sets of Random Access resources with the multiple Msg1 repetition numbers, and wherein selecting the one or more sets of Random Access resources with Msg1 repetition comprises selecting a set of Random Access resources with a highest repetition number in response to the multiple sets of Random Access resources with the multiple Msg1 repetition numbers being available.

4. The method of claim 1, wherein each of the at least one RSRP threshold is configured per bandwidth part (BWP).

5. The method of claim 1, wherein the Msg1 repetition is an independent feature of the current Random Access procedure, and the independent feature of Msg1 repetition has different Msg1 repetition numbers.

6. The method of claim 1, further comprising:
performing, by the user device, a current Random Access procedure with the one or more sets of Random Access resources with Msg1 repetition.

7. A wireless communications apparatus comprising:
a memory storing a plurality of instructions; and
at least one processor configured to execute the plurality of instructions, wherein upon execution of the plurality of instructions, the at least one processor is configured to cause the wireless communications apparatus to:
receive at least one reference signal received power (RSRP) threshold,
wherein each of the at least one RSRP threshold is associated with a respective one of multiple Msg1 repetition numbers; and
select one or more sets of Random Access resources with Msg1 repetition based on the at least one RSRP threshold.

8. The wireless communications apparatus of claim 7, wherein one or more of the multiple Msg1 repetition numbers associated with one or more of the at least one RSRP threshold is applicable for a current Random Access procedure in response to a current RSRP of a downlink pathloss reference being lower than one or more of the at least one RSRP threshold.

9. The wireless communications apparatus of claim 7, wherein the one or more sets of Random Access resources comprises multiple sets of Random Access resources with the multiple Msg1 repetition numbers, and wherein in order to select the one or more sets of Random Access resources with Msg1 repetition, the at least one processor is configured to select a set of Random Access resources with a highest repetition number in response to the multiple sets of Random Access resources with the multiple Msg1 repetition numbers being available.

10. The wireless communications apparatus of claim 7, wherein each of the at least one RSRP threshold is configured per bandwidth part (BWP).

11. The method of claim 7, wherein the Msg1 repetition is an independent feature of the current Random Access procedure, and the independent feature of Msg1 repetition has different Msg1 repetition numbers.

12. The wireless communications apparatus of claim 7, wherein the processor, upon execution of the plurality of instructions, is further configured to:
perform a current Random Access procedure with the one or more sets of Random Access resources with Msg1 repetition.

13. A non-transitory computer readable storage medium storing a plurality of instructions executable by at least one processor, wherein when executed by the at least one processor, the plurality of instructions is configured to cause a wireless communications apparatus to:
receive at least one reference signal received power (RSRP) threshold, wherein each of the at least one RSRP threshold is associated with a respective one of multiple Msg1 repetition numbers; and
select one or more sets of Random Access resources with Msg1 repetition based on the at least one RSRP threshold.

14. The non-transitory computer readable storage medium of claim 13, wherein one or more of the multiple Msg1 repetition numbers associated with one or more of the at least one RSRP threshold is applicable for a current Random Access procedure in response to a current RSRP of a downlink pathloss reference being lower than one or more of the at least one RSRP threshold.

15. The non-transitory computer readable storage medium of claim 13, wherein the one or more sets of Random Access resources comprises multiple sets of Random Access resources with the multiple Msg1 repetition numbers, and wherein in order to select the one or more sets of Random Access resources with Msg1 repetition, the plurality of instructions, when executed by the at least one processor, is configured to cause the wireless communications apparatus to select a set of Random Access resources with a highest repetition number in response to the multiple sets of Random Access resources with the multiple Msg1 repetition numbers being available.

16. The non-transitory computer readable storage medium of claim 13, wherein each of the at least one RSRP threshold is configured per bandwidth part (BWP).

17. The non-transitory computer readable storage medium of claim 13, wherein the Msg1 repetition is an independent feature of the current Random Access procedure, and the independent feature of Msg1 repetition has different Msg1 repetition numbers.

18. The non-transitory computer readable storage medium of claim 13, wherein the plurality of instructions, when executed by the at least one processor, is further configured to cause the wireless communications apparatus to:
perform a current Random Access procedure with the one or more sets of Random Access resources with Msg1 repetition.
